(19) United States
(12) Patent Application Publication
(10) Pub. No.: US 2006/0236608 A1
(43) Pub. Date: Oct. 26, 2006

(54) System for dispensing hydrogen to a vehicle

(76) Inventors: Amjad Khan, Newington, CT (US); Thomas M. Maloney, Hebron, CT (US); Lawrence Clinton Moulthrop, Windsor, CT (US); Michael Thomas Kowalski, Seymour, CT (US); Erik James White, Storrs, CT (US)

Correspondence Address: PROTON ENERGY SYSTEM, 10 TECHNOLOGY DRIVE, WALLINGFORD, CT, 06492, US

(21) Appl. No.: 11/112,608

(22) Filed: Apr. 22, 2005

(51) Int. Cl. F17D 1/04

(52) U.S. Cl. 48/190

(57) ABSTRACT

A system for delivering hydrogen to a vehicle is provided which includes a first hydrogen generator coupled to a first compressor. A second hydrogen generator is also provided that produces hydrogen gas at a pressure at least 2 times that produced by said first generator. Coupled to the second hydrogen generator is a second compressor that increases the pressure of the hydrogen gas produces to a desired delivery pressure. A storage vessel is coupled to both first and second compressors to store the hydrogen gas at a desired pressure level prior to dispensing.

### FEDERAL RESEARCH STATEMENT

This invention was made with Government support under contract DE-FG36-03GO13063 awarded by the Department of Energy. The Government has certain rights in this invention.

### FIELD OF INVENTION

This disclosure relates generally to system for generating hydrogen onsite for dispensing to a vehicle and especially to a system with multiple hydrogen generators operating at different operating parameters.

### BACKGROUND OF THE INVENTION

Due to high cost and pollution caused by hydrocarbon based vehicle fuels such as gasoline or diesel, there has been an increased interest in new clean and efficient fuels. Automobile manufacturers have designed and are manufacturing vehicles that operate on hydrogen gas using fuel cells or internal combustion engines. The clean, nonpolluting nature of systems that utilize hydrogen as a fuel gives hydrogen the potential to be the fuel of choice in the future.

Unlike traditional fuels that must be delivered to stations for distribution to the end customer, technologies are available to create hydrogen gas at the point of delivery. These technologies use base materials available at the distribution location to generate the hydrogen on-site on an as needed basis. This removes the need for large fleets of delivery vehicles to move the fuel to the distribution point.

The technologies for generating on-site hydrogen may be grouped into two broad categories, hydrocarbon reformers and water electrochemical cells. The hydrocarbon reformers take traditional fossil fuels, such as natural gas or propane and use a process to break-down the hydrocarbon fuel and remove hydrogen molecules for form hydrogen gas. The electrolysis technologies disassociate hydrogen from water through the use of a catalyst and a membrane. The membranes have a special property that allows only the hydrogen protons to migrate across allowing the hydrogen gas to be formed. Electrolysis technologies generally utilize either a polymer membrane or an alkaline based membrane to separate the hydrogen.

While all of the technologies mentioned above provide the means to produce on-site hydrogen for end-users, they typically produce the hydrogen gas at a relatively low pressure, generally between atmospheric pressure and 2758 kPa. However, due to the low energy density of hydrogen, vehicles powered by hydrogen gas must store the gas at high pressures (e.g., at pressures of 41.4 MPa or more) in order to travel any substantial range.

Accordingly, it is considered desirable to provide a system for generating hydrogen fuel on-site for use in hydrogen powered vehicles at optimal pressure levels necessary for provide adequate range for the vehicles. It is further desired to provide a system that can produce hydrogen gas at different rates and pressures depending on instantaneous volume requirements of the station.

It is still further desired to provide a system for generating hydrogen fuel on-site that allows the operator to generate sufficient hydrogen for customer needs while minimizing the energy required to generate the fuel.

It is still further desired to provide a system for delivering pressurized hydrogen fuel to a vehicle which affords better performance than the prior art, and which also overcomes many of the difficulties and disadvantages of the prior art to provide better and more advantageous results.

### SUMMARY OF THE INVENTION

A system for delivering hydrogen to a vehicle is provided which includes a first hydrogen generator coupled to a first compressor. A second hydrogen generator is also provided that produces hydrogen gas at a pressure at least 2 times that produced by said first generator. Coupled to the second hydrogen generator is a second compressor that increases the pressure of the hydrogen gas produces to a desired delivery pressure. A storage vessel is coupled to both first and second compressors to store the hydrogen gas at a desired pressure level prior to dispensing.

The system may further include optional buffer vessels coupled to the each of the compressors to provide a reservoir that prevents starvation and allows optimal utilization of the respective compressor. A secondary storage vessel may also be provided that allows additional storage capacity of the hydrogen gas.

A system for delivering hydrogen to a vehicle is also provided where a first generation means for producing hydrogen gas at a first pressure level and a first flow rate. A first buffer vessel is fluidly coupled between the first hydrogen generator and a first compression means. The first compression means increases the pressure of hydrogen gas to a second pressure level. A second generation means is provided for producing hydrogen gas at a third pressure level and a second flow rate where the third pressure level is at least 2 times that of the first pressure level. A second buffer vessel is fluidly coupled between the second generation means and a second compression means. The second compression means increases the pressure of hydrogen gas to a fourth pressure level. Finally, a first storage means is provided for storing the hydrogen gas that has been compressed by the first and second compression means.

The above discussed and other features will be appreciated and understood by those skilled in the art from the following detailed description and drawings.

### BRIEF DESCRIPTION OF THE DRAWINGS

Referring now to the drawings, which are meant to be exemplary and not limiting, and wherein like elements are numbered alike:

FIG. 1 is a schematic view of a hydrogen generation and dispensing system in accordance with the present invention.

### DESCRIPTION OF PREFERRED EMBODIMENT

Similar to conventional automobiles, vehicles powered using hydrogen as a fuel need a location where they can replenish, or re-fuel, their supply of hydrogen. Traditionally, industrial users of hydrogen had their gas delivered by large industrial gas companies that generated the hydrogen at a central facility. While a similar models could be used to distribute hydrogen for vehicle use, due to the low energy density of hydrogen, especially when compared to gasoline, the distribution points, or gas stations would require frequent refilling.

Alternatively, since hydrogen is generated from other materials, such as water or natural gas, the hydrogen could be created at the point of distribution. On-site generation also provides additional benefits of the delivery distribution model since technologies such as electrolysis and reforming are generally scalable, the fueling station could expand as the number of hydrogen powered vehicles increased in the vicinity of the station.

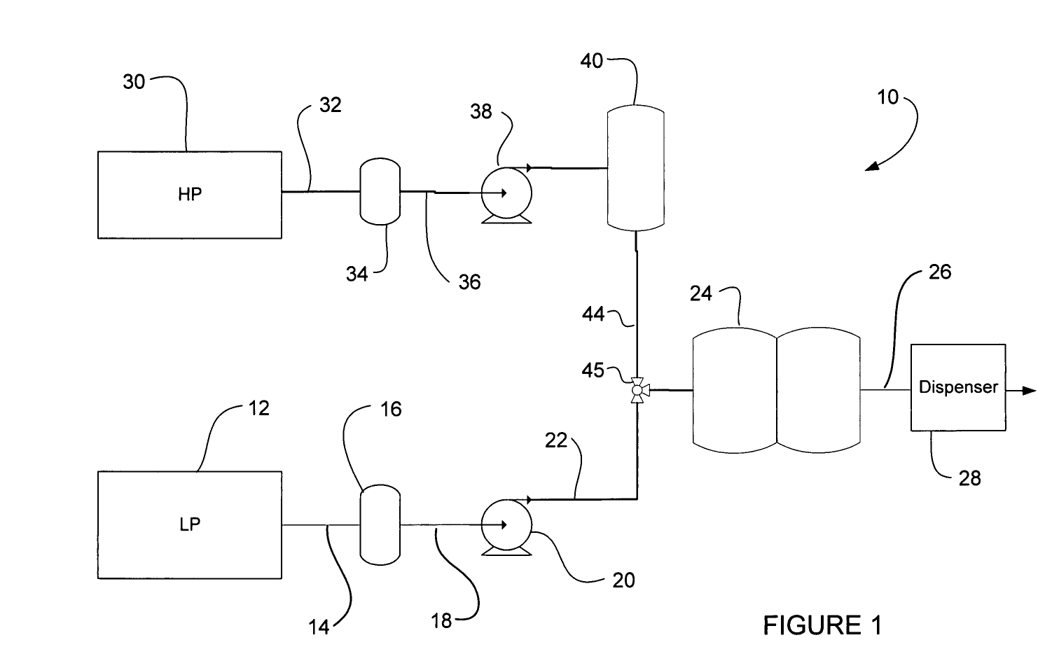

Referring to FIG. 1, an on-site hydrogen generation system is shown. A low pressure hydrogen generator 12 is coupled by a conduit 14 to an optional small buffer vessel 16. The hydrogen generator 12 includes generators such as, but not limited to, polymer electrode membrane (“PEM”) water electrolyzers, alkaline water electrolyzers, bio-mass hydrogen generators, photolysis hydrogen generators, steam-methane reformers, natural gas reformers, propane reformers, gasoline reformers, diesel reformers, JP-8 reformers, DF-2 reformers, and methanol reformers. The hydrogen generator 12 produces hydrogen gas at a predetermined flow rate, preferably between 0.5 NMˆ/hr and 50 NMˆ/hr. A normal meter cubed (“NMˆ3”) is the volume of hydrogen gas at standard temperature and pressure. For small stations, the hydrogen generator may preferably produce less than 6 NMˆ3/hr, and more preferably less than 2 NMˆ3/hr.

The low pressure hydrogen generators 12 generally produce hydrogen gas at a constant pressure and typically at a level not greater than 2758 kPa. While certain technologies, such as PEM electrolyzers, can produce gas at pressures exceeding 13.8 MPa, it is desirable to utilize the low pressure generators due to the high volume of gas they are capable of producing. As will be explained in more detail herein, it is desirable to combine the low pressure hydrogen generator 12 with a lower output high pressure generator 30 to allow the station operator to minimize energy usage in the production of hydrogen while allowing scalability of the hydrogen generation capability.

Since hydrogen fueled vehicles typically store hydrogen gas at levels greater than 34.6 MPa, and preferably at 41.4 MPa, the low pressure hydrogen gas from hydrogen generator 12 is conducted through conduits 14, 18 to compressor 20. The compressor 20, may be any suitable type, such as but not limited to a diaphragm compressor, a hydraulically-actuated diaphragm compressor, a piston compressor or a booster-ejector compressor. The compressor 20 increases the pressure of the hydrogen gas to the desired delivery pressure, preferably at least 13.8 MPa, and more preferably at least 41.4 MPa. Depending on the type of compressor that is used, the hydrogen gas may be temporarily stored in an optional buffer vessel 12 to allow a reserve of gas that prevents the compressor 20 from being starved of gas.

The conduit 22 terminates at a valve 45 that transfers the hydrogen gas to storage vessel 24. In the preferred embodiment, valve 45 is arranged to allow hydrogen gas to flow from either conduit 22 or conduit 44 individually, or from both conduits 22, 44 simultaneously. The hydrogen gas is stored in vessel 24 until it is transferred via conduit 26 to dispenser 28. The dispenser 28 delivers the hydrogen gas to the vehicle (not shown) at the desired pressure.

A high pressure hydrogen generator 30 is also provided. The hydrogen generator 30 is typically a type, such as but not limited to a water electrolysis cell, that is capable of producing hydrogen gas at a higher pressure level than low pressure hydrogen generator 12. In the preferred embodiment, the hydrogen generator 30 produces hydrogen gas at a pressure level at least 2 times that of hydrogen generator 12, and more preferably at a level at least ten times that of hydrogen generator 12. The hydrogen generator 30 also produces hydrogen gas at a lower flow rate, preferably at half the rate of hydrogen generator 12. In the preferred embodiment, the hydrogen generator 30 is a PEM electrolysis cell that produces hydrogen at a pressure between 1.38 MPa and 69 MPa, and more preferably at 13.8 MPa at a flow rate between 0.5 NMˆ3/hr and 50 NMˆ3/hr.

The hydrogen gas exits hydrogen generator 30 and travels via conduits 32, 36 to compressor 38. Compressor 38, which may be any suitable type, such as but not limited to a diaphragm compressor, a hydraulically-actuated diaphragm compressor, a piston compressor or a booster-ejector compressor, increases the pressure of the hydrogen gas from the generated level to the desired storage pressure. An optional buffer vessel 34, is provided depending on the needs of the compressor to prevent the starving of the compressor due to an inadequate supply. The compressed hydrogen exits the compressor 38 and enters an optional secondary storage vessel 40 before traveling via conduit 44 through valve 45 to storage vessel 24. It should be appreciated that the system described is scalable in nature and the utilization of a secondary storage vessel 24 may be used to increase the capacity of the system depending on the needs of the station operator.

As discussed above, certain hydrogen generation technologies, namely PEM-type electrolysis cells, are capable of producing hydrogen gas at higher levels up to 69 MPa. Due to the costs involved in producing these higher pressure electrochemical cells, the output or flow rate of these generators tends to be lower. However, a number of advantages may be gained by incorporating a high pressure hydrogen generator into a system. Since the output of the hydrogen generator is higher, preferably between 2.8 MPa and 13.8 MPa, a smaller compressor or an alternate compressor such as a booster-ejector type compressor may be used. Additionally, the lower flow rate hydrogen generator and smaller compressor require less energy for operation than the low pressure, larger compressor combination. This allows the station operator to selectively generate hydrogen to minimize energy consumption depending on the electricity rate the operator is being charged by the electrical utility.

In areas where the electrical utility uses a system known as “net metering”, electricity users are charged different rates at different times of the day. For example, typically electricity rates are lowest at night when demand is low and generating capacity is high. This situation makes it preferable for the station operator to operate the higher energy consumption process (low pressure hydrogen generator) at night to generate a bulk of the needed hydrogen. Conversely, the operator can still generate hydrogen during the day, utilizing the high pressure hydrogen generator to maintain an adequate supply. Using the system described herein, the station operator also maintains the ability to run both hydrogen generators if there is a peak demand period by customers refueling their vehicles.

While the invention has been described with reference to a preferred embodiment, it will be understood by those skilled in the art that various changes may be made and equivalents may be substituted for elements thereof without departing from the scope of the invention. In particular, the specific embodiment described herein referred to the operation of two hydrogen generators, however, this was for exemplary purposes only, and there are no constrains to operating any number of high and low pressure hydrogen generators combination to meet the demand. In addition, may modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A system for delivering hydrogen to a vehicle comprising:
a first hydrogen generator;
a first compressor fluidly coupled to said first generator;
a second hydrogen generator, said second generator producing hydrogen gas at a pressure at least 2 times that produced by said first generator;
a second compressor fluidly coupled to said second hydrogen generator; and,
a first storage vessel fluidly coupled to said first and second compressors.

2. The system for delivering hydrogen to a vehicle of claim 1 wherein said second hydrogen generator produces hydrogen gas at a pressure at least ten times that produced by the first hydrogen generator.

3. The system for delivering hydrogen to a vehicle of claim 2 wherein said second hydrogen generator produces hydrogen at a rate equal to or less than half the rate of said first hydrogen generator.

4. The system for delivering hydrogen to a vehicle of claim 3 wherein said second hydrogen generator is a polymer electrode membrane electrolysis cell.

5. The system for delivering hydrogen to a vehicle of claim 4 wherein said first hydrogen generator is a polymer electrode membrane electrolysis cell.

6. The system for delivering hydrogen to a vehicle of claim 4 wherein said first hydrogen generator is a hydro-carbon reformer.

7. The system for delivering hydrogen to a vehicle of claim 4 wherein said first hydrogen generator produces hydrogen gas at a rate between of 0.5 NMˆ3/hr and 50 NMˆ3/hr.

8. The system for delivering hydrogen to a vehicle of claim 7 wherein said first hydrogen generator produces hydrogen gas at a rate of less than 6 NMˆ3/hr.

9. The system for delivering hydrogen to a vehicle of claim 8 wherein said first hydrogen generator produces hydrogen gas at a rate of less than 2 NMˆ3/hr.

10. The system for delivering hydrogen to a vehicle of claim 4 further comprising a second storage vessel fluidly coupled between said first storage vessel and said second compressor.

11. The system for delivering hydrogen to a vehicle of claim 4 wherein said first compressor is a type chosen from a group consisting of: diaphragm compressors, hydraulically-actuated diaphragm compressors, piston compressors or booster-ejector compressors.

12. A system for delivering hydrogen to a vehicle comprising:
a first generation means for producing hydrogen gas at a first pressure level and a first flow rate;
a first buffer vessel fluidly coupled to said first hydrogen generator;
a first compression means for increasing the pressure of hydrogen gas to a second pressure level, said first compression means being fluidly coupled to said first buffer vessel;
a second generation means for producing hydrogen gas at a third pressure level pressure and a second flow rate, said third pressure level being at least 2 times that of said first pressure level;
a second buffer vessel fluidly coupled to said second generation means;
a second compression means for increasing the pressure of hydrogen gas to fourth pressure level, said second compression means being fluidly coupled to said second buffer vessel; and,
a first storage means for storing said hydrogen gas, said first storage means being fluidly coupled to said first and second compression means.

13. The system for delivering hydrogen to a vehicle of claim 12 wherein said second pressure is produced at a pressure ten times that of the first pressure.

14. The system for delivering hydrogen to a vehicle of claim 13 wherein said second flow rate of hydrogen gas is at a rate equal to or less than half the first flow rate.

15. The system for delivering hydrogen to a vehicle of claim 14 wherein said first flow rate is between 0.5 NMˆ3/hr and 50 NMˆ3/hr.

16. The system for delivering hydrogen to a vehicle of claim 15 wherein said first pressure level is between 344.7 kPa and 2758 kPa.

17. The system for delivering hydrogen gas to a vehicle of claim 16 wherein said second pressure level is greater than 41.4 MPa

18. The system for delivering hydrogen gas to a vehicle of claim 17 wherein said fourth pressure level is equal to said second pressure level.

19. The system for delivering hydrogen to a vehicle of claim 14 wherein said first generation means is chosen from a group comprising: PEM electrochemical cells, water electrolyzers, alkaline water electrolyzers, bio-mass hydrogen generators, photolysis hydrogen generators, steam-methane reformers, natural gas reformers, propane reformers, gasoline reformers, diesel reformers, JP-8 reformers, DF-2 reformers, and methanol reformers.

20. The system for delivering hydrogen to a vehicle of claim 19 wherein said first compression means is a diaphragm-type compressor and said second compression means is a piston compressor.
